(19) United States
(12) Patent Application Publication
(10) Pub. No.: US 2022/0170761 A1
(43) Pub. Date: Jun. 2, 2022

(54) METHOD AND APPARATUS FOR DETECTING/VERIFYING CONTRAFLOW LANE SHIFT INCIDENTS

(71) Applicant: HERE Global B.V., Eindhoven (NL)

(72) Inventors: OMER MUBAREK, Chicago, IL (US); Colin WATTS-FITZGERALD, Chicago, IL (US)

(21) Appl. No.: 17/107,349

(22) Filed: Nov. 30, 2020

(51) Int. Cl. G01C 21/36; G01C 21/30

(52) U.S. Cl. CPC G01C 21/3691; G01C 21/30

(57) ABSTRACT

An approach is provided for detecting/verifying contraflow lane shift incidents using bidirectional lateral distance measurements. The approach involves, for example, for each one of a plurality of vehicle data points travelling at a main direction of a main side of a bi-directional road, determining a first lateral distance to a center of the main side and a second lateral distance to a center of an opposite side of the bi-directional road. The approach also involves, for the plurality of vehicle data points, aggregating the first lateral distance into a main feature and aggregating the second lateral distance into an opposite feature. The approach further involves identifying a lane shift to the opposite side based on the main feature, the opposite feature, or a combination thereof. The approach further involves providing the lane shift as an output.

### BACKGROUND

Providing data on traffic anomalies or incidents (e.g., abnormalities in traffic that can affect traffic flow such as accidents, lane closures, road closures, etc.) is an important function for mapping service providers. For instance, once a road closure is reported (e.g., by a third-party provider), service providers regularly use global positioning system (GPS) probe data to generate vehicle paths to verify and monitor traffic conditions in the affected area. However, due to location sensor accuracy limitations and/or map matching errors, for example, the reported incidents frequently suffer from data quality issues/inaccuracies, and require verification. Incorrect incident data can have drastic impact on routing, estimated time of arrival accuracy, and has implications for the safety of autonomous vehicle driving. Current lateral distance measurement strategies for detecting/verifying road closures require historical data and suffer from errors caused by road structures such as ramps. Accordingly, mapping service providers face significant technical challenges to automatically detect/verify traffic conditions (e.g., road closures) using lateral distance measurements.

### SOME EXAMPLE EMBODIMENTS

Therefore, there is a need for an approach for detecting/verifying contraflow lane shift incidents using bidirectional lateral distance measurements using a simple and fast lateral distance measurement scheme, such as bidirectional lateral distance measurements.

According to one embodiment, a method comprises for each one of a plurality of vehicle data points travelling at a main direction of a main side of a bi-directional road, determining a first lateral distance to a center of the main side and a second lateral distance to a center of an opposite side of the bi-directional road. The method also comprises for the plurality of vehicle data points, aggregating the first lateral distance into a main feature and aggregating the second lateral distance into an opposite feature. The method further comprises identifying a lane shift to the opposite side based on the main feature, the opposite feature, or a combination thereof. The method further comprises providing the lane shift as an output.

According to another embodiment, an apparatus comprises at least one processor, and at least one memory including computer program code for one or more computer programs, the at least one memory and the computer program code configured to, with the at least one processor, cause, at least in part, the apparatus to determine, for each one of a plurality of vehicle data points travelling at a main direction of a main side of a bi-directional road, a first lateral distance to a center of the main side and a second lateral distance to a center of an opposite side of the bi-directional road. The apparatus is also caused to, for the plurality of vehicle data points, aggregate the first lateral distance into a main feature and aggregate the second lateral distance into an opposite feature. The apparatus is further caused to identify a lane shift to the opposite side based on the main feature, the opposite feature, or a combination thereof. The apparatus is further caused to provide the lane shift as an output.

According to another embodiment, a non-transitory computer-readable storage medium carries one or more sequences of one or more instructions which, when executed by one or more processors, cause, at least in part, an apparatus to process probe data to determine, for each one of a plurality of vehicle data points travelling at a main direction of a main side of a bi-directional road, a first lateral distance to a center of the main side and a second lateral distance to a center of an opposite side of the bi-directional road. The apparatus is also caused to, for the plurality of vehicle data points, aggregate the first lateral distance into a main feature and aggregate the second lateral distance into an opposite feature. The apparatus is further caused to identify a lane shift to the opposite side based on the main feature, the opposite feature, or a combination thereof. The apparatus is further caused to provide the lane shift as an output.

According to another embodiment, an apparatus comprises for each one of a plurality of vehicle data points travelling at a main direction of a main side of a bi-directional road, means for determining a first lateral distance to a center of the main side and a second lateral distance to a center of an opposite side of the bi-directional road. The apparatus also comprises for the plurality of vehicle data points, means for aggregating the first lateral distance into a main feature and aggregating the second lateral distance into an opposite feature. The apparatus further comprises means for identifying a lane shift to the opposite side based on the main feature, the opposite feature, or a combination thereof. The apparatus also comprises means for providing the lane shift as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting/verifying contraflow lane shift incidents using bidirectional lateral distance measurements, according to one embodiment;

FIG. 2A is a diagram of an example contraflow lane shift incident, according to one embodiment;

FIG. 2B is a diagram of example lateral distance measurements on a bi-directional road, according to one embodiment;

FIG. 2C is a diagram of example median D and D′ values on a bi-directional road, according to one embodiment;

FIG. 3 is a diagram of the components of a traffic platform configured to detect/verify contraflow lane shift incidents using bidirectional lateral distance measurements, according to one embodiment;

FIG. 4 is a flowchart of a process for detecting/verifying contraflow lane shift incidents using bidirectional lateral distance measurements, according to one embodiment;

FIG. 5 is a diagram of a partially shared roadway incident, according to one embodiment;

FIGS. 6A-6B are diagrams for an example road segment before and during a contraflow lane shift incident, according to one embodiment;

FIGS. 7A and 7B are diagrams of example user interfaces of a detected contraflow lane shift incident, according to various embodiment;

FIG. 8 is a diagram of a geographic database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal (e.g., handset or vehicle or part thereof) that can be used to implement an embodiment.

### DESCRIPTION OF SOME EMBODIMENTS

Examples of a method, apparatus, and computer program for detecting/verifying contraflow lane shift incidents using bidirectional lateral distance measurements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

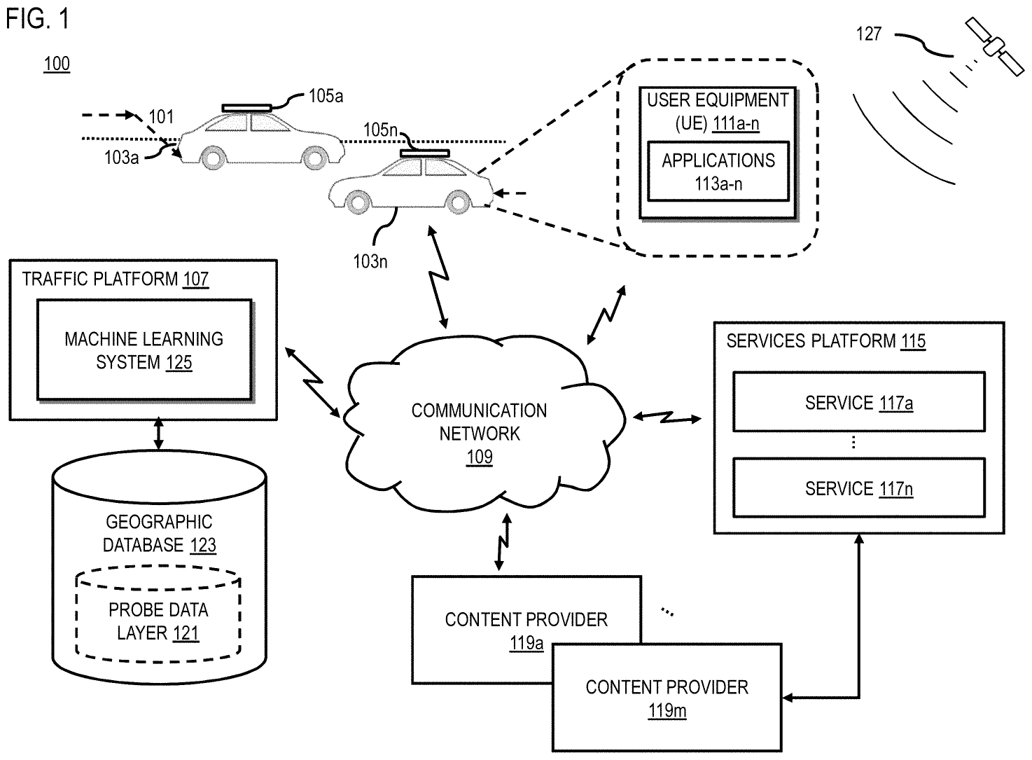

FIG. 1 is a diagram of a system capable of detecting/verifying contraflow lane shift incidents using bidirectional lateral distance measurements, according to one embodiment. The term contraflow refers to a situation in which vehicles travelling in a specific direction of a road have to use one or more lanes that are normally allocated to vehicles travelling in the opposite direction. The terms contraflow lane shift incident, lane shift, contraflow lane reversal incident, road sharing lane closure, road sharing incident, etc. are used interchangeably herein after.

As mentioned above, providing data on traffic anomalies or incidents (e.g., abnormalities in traffic that can affect traffic flow such as accidents, lane closures, road closures, etc.) is an important function for mapping service providers. While most traffic anomalies can have at least some negative impact on traffic, road closures can be the most severe due to total or partial traffic blockage. While lane/road closures are published by government/municipality agencies, local police, third parties, and semi-official sources, the information does not offer complete/comprehensive coverage. In addition, these sources frequently suffer from data quality issues/inaccuracies, such as location sensor accuracy limitations and/or map matching errors, thus require verification. Moreover, obtaining accurate, real-time traffic information regarding road closures is particularly important for autonomous driving.

The current incident detecting techniques measure lateral distances from a vehicle path to a reference line on the roadway (“D-values”) to identify vehicle lane-level information. For instance, the techniques compare the vehicle GPS coordinates to the shape points of the roadway to identify a lateral distance of a vehicle probe to the center line of the roadway. This would give the theoretical GPS “distance” (D-value) from the center line of the roadway. The d-values can be used to identify lane information of the roadway, thereby deriving road/lane closures/shifts. However, the D-Value data, while valuable, can be inaccurate/tricky depending on roadway structures and statistical variability of GPS data. In addition, the current incident detecting techniques require some forms of contextual data (e.g., historical D-values). Accordingly, mapping service providers face significant technical challenges to automatically verify traffic conditions (e.g., road closures) using the d-values.

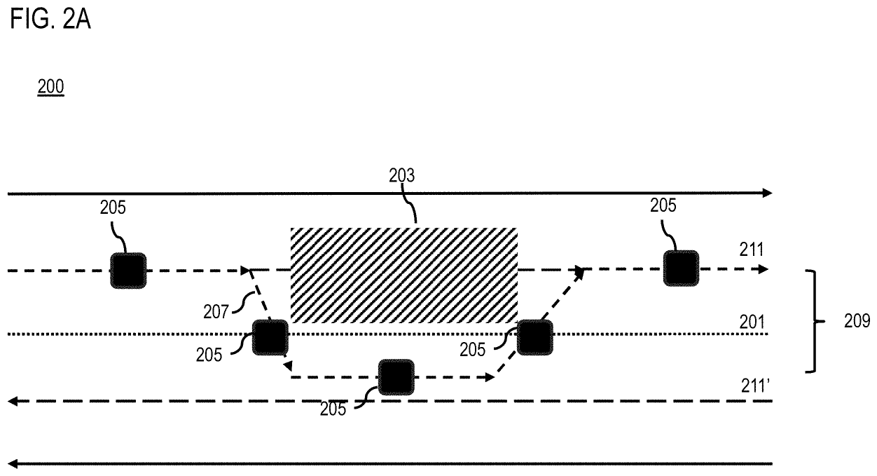

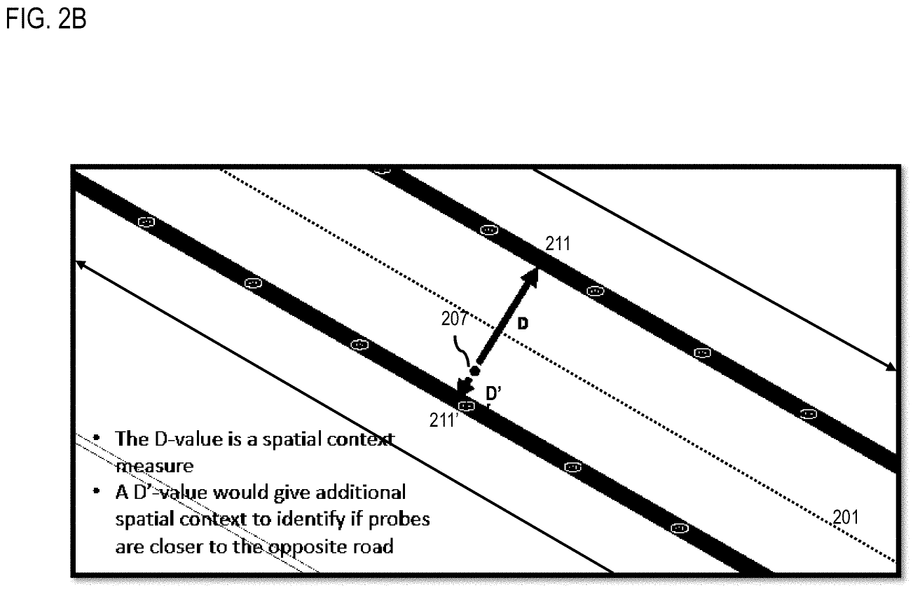

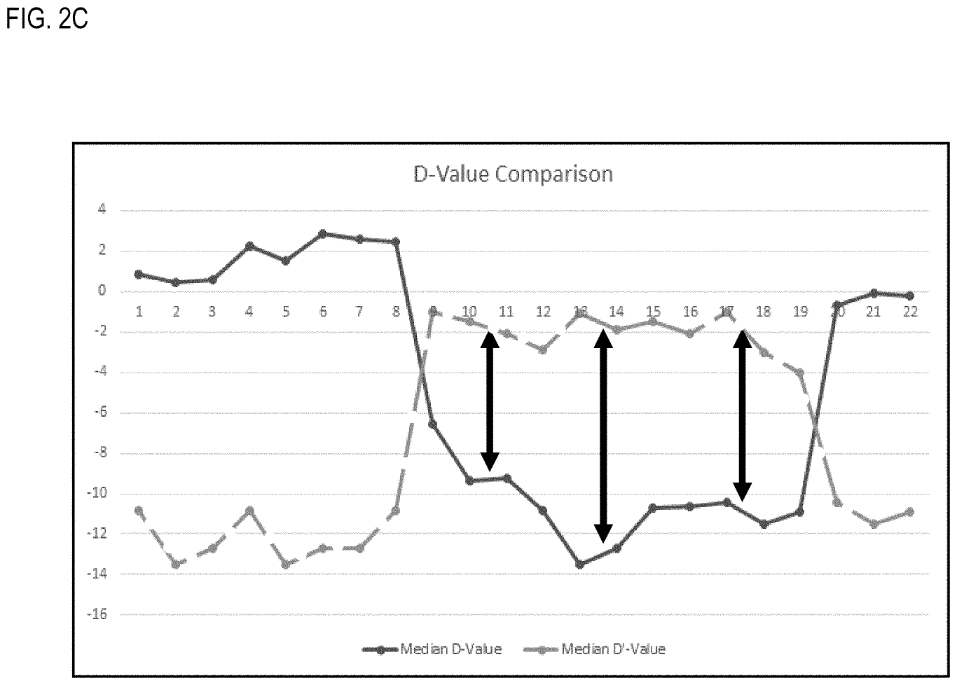

To address these problems, the system 100 of FIG. 1 introduces a capability to automatically verify a reported/detected road closure using GPS probe data. In one embodiment, the system 100 can use probe data, sensor data, and/or machine learning solutions to automatically detect/verify a roadway incident, especially a road/lane closure 101 that results in contraflow. The term contraflow refers to a situation during roadworks in which vehicles travelling in a specific direction of the road have to use the lanes that are normally allocated to vehicles in the opposite direction (See FIG. 2A). FIG. 2A is a diagram of an example contraflow lane shift incident, according to one embodiment. FIG. 2A displays a bi-directional road 200 with a road center line 201, a main side along the main traffic direction (e.g., right), and an opposite side along an opposite traffic direction (e.g., left). Due to an obstacle 203 (e.g., a broken vehicle, a construction zone, etc.) on the main side of the road 200, a vehicle 205 is forced to take a detour 207 and travels into the opposite side of the road 200 to circumvent the obstacle 203, which constitutes a contraflow lane shift incident 209.

By way of example, the system 100 can use multiple lateral distance measurements on the bi-directional road 200 based on vehicle probe data, sensor data, and/or connected strand graphs (e.g., the road center line 201, a lane center line 211 on the main side, a lane center line 211′ on the opposite side, etc.) to identify where the traffic flow is diverted to the opposite side of the road 200. FIG. 2B is a diagram of example lateral distance measurements on a bi-directional road, according to one embodiment. FIG. 2B shows a spatial context measure (“D-value”, e.g., a lateral distance measured from a location point of the vehicle 205 to the lane center line 211 on the main side, and another spatial context measure (“D′-value”, e.g., a lateral distance measured from the location point to the lane center line 211′ on the opposite side. The location point can be extracted from probe data and/or sensor data. The D′-value can give additional spatial context to identify whether vehicle data points are located closer to the opposite side of the road 200.

In one embodiment, the system 100 can aggregate the (D, D′) values across vehicles and across roadway subsegments (links) to allow for statistical modeling of the data into features that can be used for probabilistic based solutions, machine learning solutions, etc., leveraging vehicle location data features. These solutions can be applied to identify situations where consistently and distinctly the spatial data shows that traffic has been diverted, such as the contraflow lane shift incident 209. FIG. 2C is a diagram of example median D and D′ values on a bi-directional road, according to one embodiment. FIG. 2C shows median D and D′ values spatially across a roadway segment (e.g., marked in the x-axis from 0 meter to 22 meters), where the lane center line 211 is located at a lateral position 0, and vehicles were redirected to use the opposite side of the road about 10-12 meters away from the lane center line 211 on the y-axis. For instance, the crossover of (D, D′) values can algorithmically identify a contraflow lane shift incident (e.g., the contraflow lane shift incident 209).

In short, the system 100 can verifies a contraflow lane shift incident by: building a connected road graph based on vehicle location data, monitoring the vehicle location data received on the road segments within this connected road graph, building vehicle paths/trajectories for each vehicle, identifying driving patterns from these vehicle paths/trajectories, and algorithmically identifying a contraflow lane shift incident based on D, D′ values.

In one embodiment, the system 100 determines the road graph and/or flow of traffic by processing probe data and/or sensor data from one or more vehicles 103a-103n (also collectively referred to as vehicles 103) (e.g., standard vehicles, autonomous vehicles, heavily assisted driving (HAD) vehicles, semi-autonomous vehicles, etc.). In one instance, the vehicles 103 include one or more vehicle sensors 105a-105n (also collectively referred to as vehicle sensors 105) and have connectivity to a traffic platform 107 via a communication network 109. By way of example, a vehicle sensor 105 may include a RADAR system, a LiDAR system, a global positioning sensor for gathering probe data (e.g., GPS probe data). In one embodiment, the probe data may be reported as probe points, which are individual data records collected at a point in time that records telemetry data for that point in time. A probe point can include attributes such as: (1) probe ID, (2) longitude, (3) latitude, (4) heading, (5) speed, and (6) time.

In another embodiment, the system 100 can also collect probe data from one or more user equipment (UE) 111a-111n (also collectively referenced to herein as UEs 111) associated with the vehicles 103 (e.g., an embedded navigation system), users or passengers of the vehicles 103 (e.g., a mobile device, a smartphone, a client terminal, etc.), or a combination thereof. In one instance, the UEs 111 may include one or more applications 113a-113n (also collectively referred to herein as applications 113) (e.g., a navigation or mapping application). In one embodiment, the system 100 may also collect the probe data and/or sensor data from one or more other sources such as government/municipality agencies, local or community agencies (e.g., police departments), and/or third-party official/semi-official sources (e.g., a services platform 115, one or more services 117a-117n, one or more content providers 119a-119m, etc.). In one instance, the probe data collected by the vehicle sensors 105, the UEs 111, one or more other sources, or a combination thereof may be stored in a probe data layer 121 of a geographic database 123 or a combination thereof.

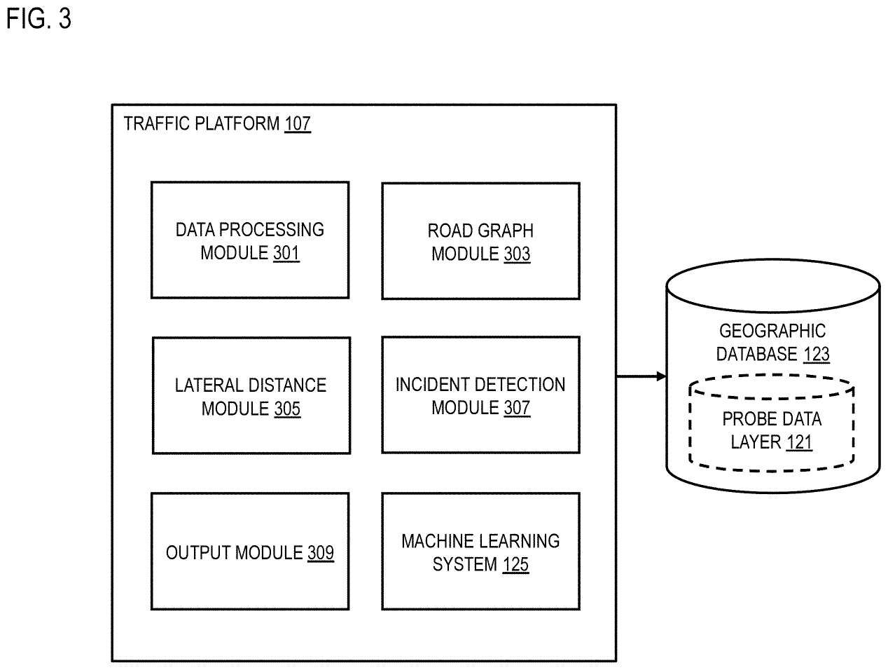

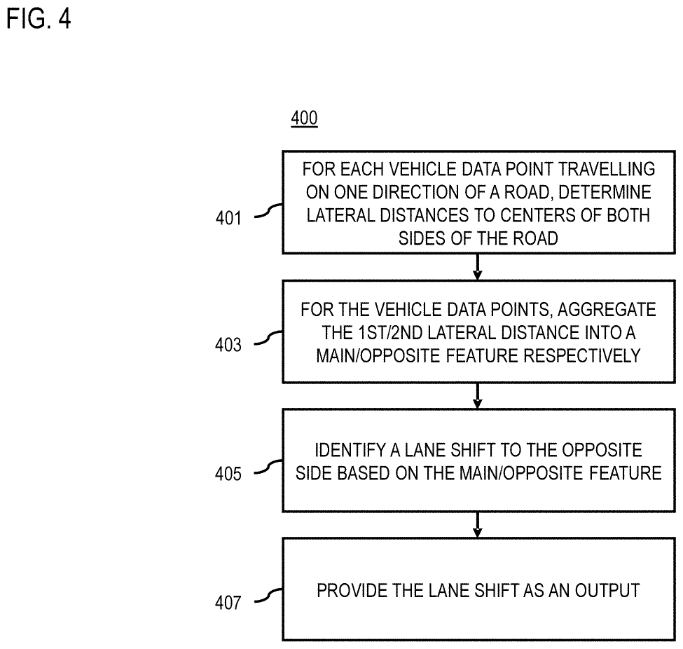

FIG. 3 is a diagram of the components of the traffic platform 107, according to one embodiment. By way of example, the traffic platform 107 includes one or more components for detecting/verifying contraflow lane shift incidents using bidirectional lateral distance measurements, according to the various embodiments described herein. It is contemplated that the functions of these components may be combined or performed by other components of equivalent functionality. In one embodiment, the traffic platform 107 includes an data processing module 301, a road graph module 303, a lateral distance module 305, an incident detection module 307, an output module 309, and a machine learning system 125, and has connectivity to the geographic database 123 including the probe data layer 121. The above presented modules and components of the traffic platform 107 can be implemented in hardware, firmware, software, or a combination thereof. Though depicted as a separate entity in FIG. 1, it is contemplated that the traffic platform 107 may be implemented as a module of any other component of the system 100. In another embodiment, the traffic platform 107 and/or the modules 301-309 may be implemented as a cloud-based service, local service, native application, or combination thereof. The functions of the traffic platform 107, the machine learning system 125, and/or the modules 301-309 are discussed with respect to FIG. 4-7.

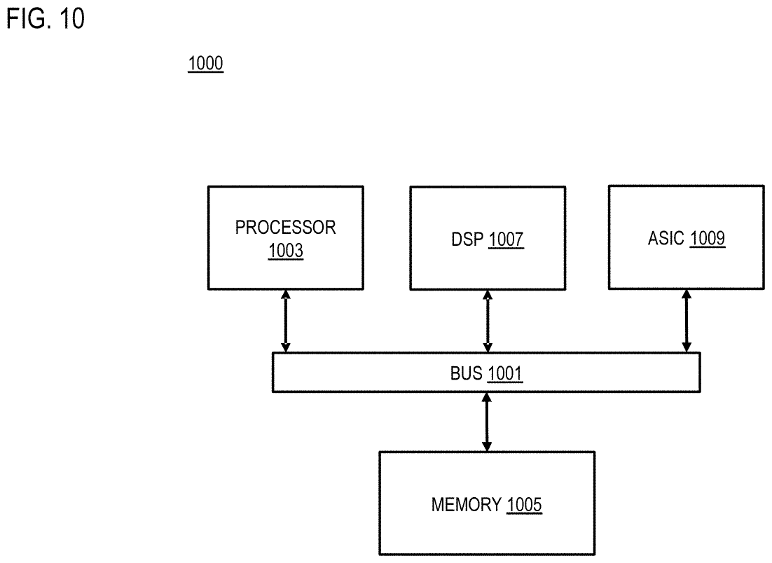

FIG. 4 is a flowchart of a process for detecting/verifying contraflow lane shift incidents using bidirectional lateral distance measurements, according to one embodiment. In various embodiments, the traffic platform 107, the machine learning system 125, and/or any of the modules 301-309 may perform one or more portions of the process 400 and may be implemented in, for instance, a chip set including a processor and a memory as shown in FIG. 10. As such, the traffic platform 107, the machine learning system 125, and/or the modules 301-309 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

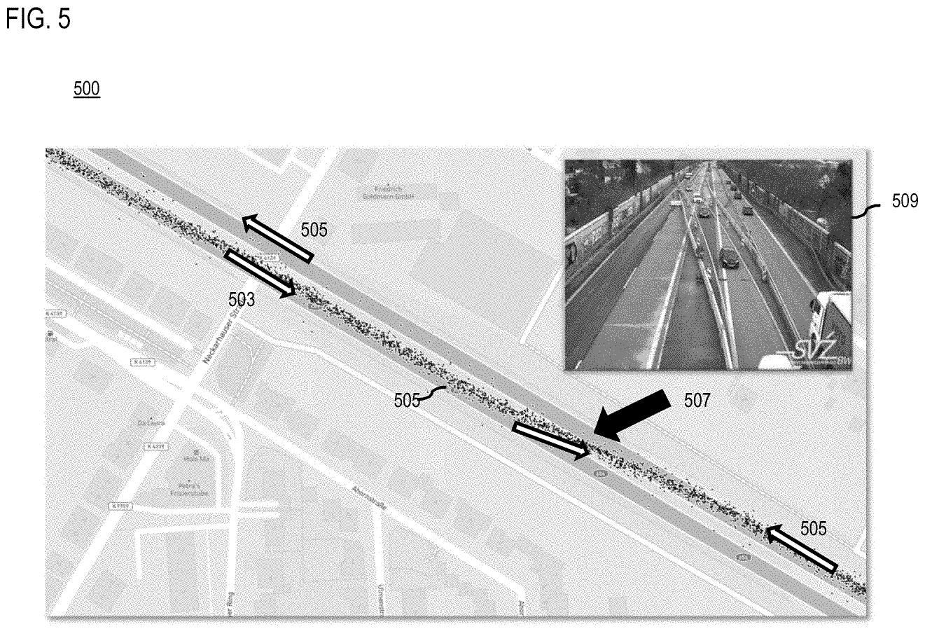

In one embodiment, the traffic platform 107 can leverages spatial features and/or other features (such as speed) of aggregated probe/sensor data to show that vehicle paths have transitioned off the intended roadway yet continue to flow, of example, due to an incident/lane-closure/road closure. In this case, the vehicles 103 on a main side of the road can be diverted to share the opposite side of the road fully or partially. FIG. 5 is a diagram of a partially shared roadway incident, according to one embodiment. The diagram 500 shows vehicle location data points 501 on a bidirectional road with two lanes on each side, arrows 503 of the main traffic flow (from up left conner towards down right corner), and arrows 505 of the opposite traffic flow. The vehicle location data points 501 demonstrate a crossover of vehicles of the main traffic flow shifting into an inner lane of the opposite side of the opposite traffic flow at a location pointed by an arrow 507. The diagram 500 also shows am image 509 of the partially shared roadway incident viewing from the opposite side of the road with the inner lane used by the main direction traffic and the outer lane used by the opposite direction traffic due to a lane/road closure on the main side of the road. The lane/road closure allows for a continuous flow in the main direction past a roadway construction.

For example, the traffic platform 107 can leverage statistical modeling of how vehicle probe data and/or sensor data change laterally, compare lateral distances for both sides of a bi-directional road, to detect a shared roadway incident (e.g. the a contraflow lane shift incident 209 in FIG. 2A) via calculating lateral distance features with one or more algorithmic solutions. The features can provide further context for identifying, detecting, and/or verifying potential lane/road closures that are diverted into the oncoming roadway.

For instances, the traffic platform 107 can either be provided a potential incident to monitor/verify, or the traffic platform 107 can be looking to detect potential incidents on roadways where no incident data exists. In both cases, the data processing module 301 can retrieve probe/sensor data for the road graph module 303 to create a full/main strand graph of the bidirectional road (e.g., the two-lane road 200 in FIG. 2A, the four-lane road in FIG. 5, etc.), expand both upstream/downstream of the potential incident area (including incoming/outgoing road segments that feed into/out of the strand). Once the full/main strand graph is created, the data processing module 301 can create the “sister”/opposite strand graph. In most cases, the opposite strand graph shall mirror the main strand graph as most bidirectional roads are designed. However, should no mirror exist, this portion of the roadway can be dropped, since the road can be a single directional road, or there are significant probe/sensor data statistical variability and/or errors.

In another embodiment, the road graph module 303 can retrieve a main strand graph of the main side of the bi-directional road, algorithmically determine an opposite strand graph of the opposite side of the bi-directional road based on the main strand graph. A road graph (e.g., a closure link graph) represents a road link and one or more other road links entering or exiting the road link. The road graph module 303 can then determine a center or a center line of the main side, and determine a center or a center line of the opposite side of the bi-directional road, based on the main strand graph and the opposite strand graph respectively.

The data processing module 301 can continuously retrieve probe/sensor data from vehicles traveling through the main strand graph area that is being monitored, for the road graph module 303 to retrieve/create the main and opposite strand graphs of the bi-directional road. Probe/sensor data would include location data, such as GPS, heading, as well as other information (speed, vehicle frequency, etc.).

In one embodiment, in step 401, the lateral distance module 305 can determine a first lateral distance (e.g., “D-value” in FIG. 2B) to a center of the main side and a second lateral distance (e.g., “D′-value” in FIG. 2B) to a center of an opposite side of the bi-directional road, for each one of a plurality of vehicle data points travelling at a main direction of a main side of a bi-directional road. By way of example, the plurality of vehicle data points include one or more probe data points, one or more sensor data points, or a combination thereof.

In one embodiment, the lateral distance module 305 can automatically calculate the D values and/or the D′ values. As probe/sensor data comes in, the lateral distance of a probe or sensor data point to a map-matched center of the road (“D-value”) can be calculated. D-values provide spatial context of the vehicle as to its location on the road and can be used to identify where the vehicle is relative to the center of the road it is map-matched on. This method would further add to the spatial context by also calculating the D-value of a vehicle to the opposite “mirrored” strand as well and call it D′-value (see FIG. 2B). By doing this the algorithm would have a tuple of lateral distance values per vehicle data point that tells how close each point is to both sides of the road.

In one embodiment, in step 403, the lateral distance module 305 can aggregate the first lateral distance (e.g., “D-values”) into a main feature and aggregate the second lateral distance into an opposite feature (e.g., “D′-values”), for the plurality of vehicle data points. In one embodiment, the first/main lateral distance is calculated during a map-matching process of a main strand graph of the main side of the bi-directional road. In another embodiment, the second/opposite lateral distance is calculated during the map-matching process of the main strand graph.

One example of the map-matching process works as described in the following section. A digital map is defined by a set of links and their geographic coordinates. Because GPS (or other similar location positioning technology) is not 100% accurate, the coordinates of a vehicle sensor 105 (e.g., a GPS probe) often do not fall perfectly onto a link. To account for this error, the system 100 (e.g., using one or more map matching algorithms) takes the coordinates of a GPS probe, and finds the neighboring links whose coordinates are close to the probe. The system 100 then places the vehicle probe 105 onto the most probable link based on pre-defined criteria of the specific map matching process or algorithm being used.

In one embodiment, to better control for map matching error, the system 100 uses vehicle paths instead of map-matched vehicle probes. The reason is that map-matched vehicle probes are more susceptible to map matching errors than vehicle paths. For example, a vehicle path or trajectory is generally derived from two consecutive map-matched vehicle probes and new paths are built on top of the previously calculated vehicle path. Hence, a vehicle path generated in this manner will be more prone to map matching errors.

In one embodiment, in step 405, the incident detection module 307 can identify a lane shift to the opposite side based on the main feature, the opposite feature, or a combination thereof. For instance, the incident detection module 307 can identify the lane shift where the line corresponding to the first/main feature is diverted to the opposite side. D-Values can be used in conjunction with historical spatial and/or temporal context to identify a contraflow lane shift as follows.

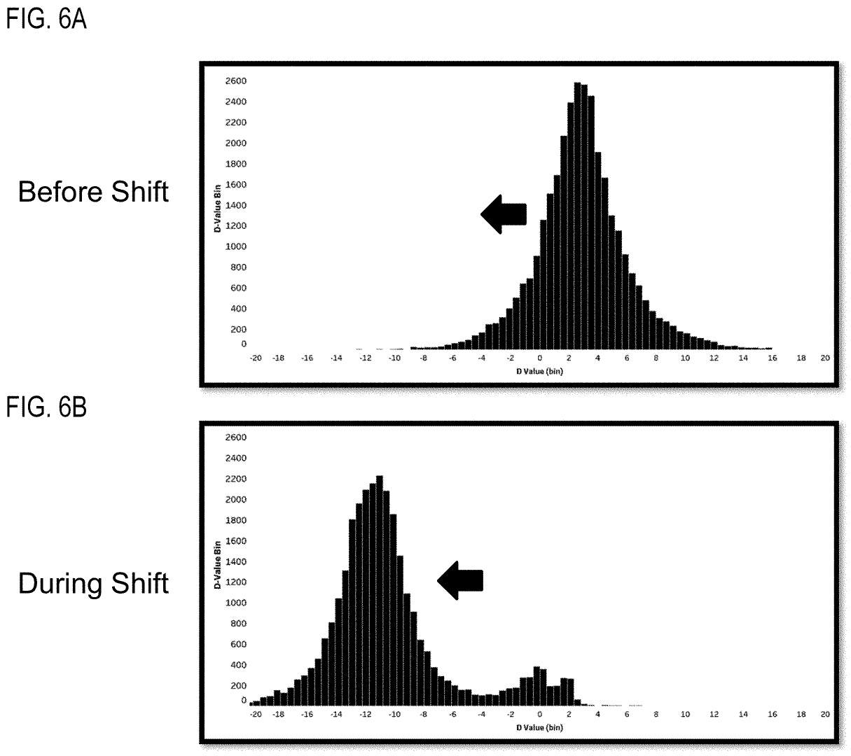

FIGS. 6A-6B are diagrams for an example road segment before and during a contraflow lane shift incident, according to one embodiment. The diagrams have the locations in the lateral direction across a bidirectional road on the x-axis, and the counts of vehicle data points on the y-axis. In FIG. 6A, during a monitored time period before the lane shift, the D-Values were centered near 0 location (e.g., the centerline of the main traffic flow) as expected under normal conditions. During the lane shift in FIG. 6B, the lateral distance from the main side center line shifted dramatically to the left as traffic was diverted onto the opposite directional roadway about 10-12 meters away from the 0 location.

As another instance, the incident detection module 307 can work in conjunction with the lateral distance module 305 to identify the lane shift based on both the first/main feature and the second/opposite feature. By way of examples, for each said vehicle data point, the lateral distance module 305 can calculate a median, a mean, a percentile (e.g., 95%), or a combination thereof of the first lateral distance and the second lateral distance respectively. The lateral distance module 305 can then aggregate the median, the mean, the percentile, or a combination thereof to generate the main feature and the opposite feature respectively.

Taking FIG. 2C as an example, the lateral distance module 305 can calculate a median of the first lateral distance and the second lateral distance (e.g., (D, D′) values) respectively, for each said vehicle data point of vehicle 103 across a road segment of interest. In FIG. 2C, the main feature depicted as a median D line (in a solid line) is close to the 0 location (e.g., the center line of the main roadway), until the 8 meter mark form the beginning of the segment of the main side of the road. The median D line then moves across to the opposite side of the road after the 8 meter mark, and then moves back to be close to the 0 location after the 19 meter mark. On the other hand, the opposite feature depicted as a median D′ line (in a broken line) mirroring the median D line. Since the opposite feature reflects the same set of vehicle data points measured against the center line of the opposite side of the road, the median D′ line should and does mirror the median D line. With the main and opposite features built on (D, D′) values, the incident detection module 307 can identify a “flip” in the main and opposite features thus a contraflow lane shift incident (e.g., the contraflow lane shift incident 209). The D′ values and/or the opposite feature provide the extra context needed to show more than just a D-value shift has occurred. In this case, the contraflow lane shift can be identified based on real-time probe/sensor data without historical spatial and/or temporal context. Such (D, D′) values aggregation approach is simple. In addition, the (D, D′) values aggregation approach is computational inexpensive. Moreover, the (D, D′) values aggregation approach is less susceptible to location sensor data statistical variability and/or errors caused by road structures, since the errors impact the D values and the D′ values equally or substantially equally, so as to be cancelled out by using both (D, D′) values. For instance, a road structure (such as a ramp) can cause D values shift rightward, that does not represent any lane shift.

In another embodiment, the incident detection module 307 can explore features other than lateral distances, such as speeds, speed changes, etc. to identify/verify lane shift incidents. In yet another embodiment, the incident detection module 307 can use the lateral distance features and/or the other features to identify/verify lane shift incidents.

In another embodiment, when there are low real-time probe/sensor data volume (e.g., less traveled roads) to generate the main and opposite features, the incident detection module 307 can supplement the main and opposite features with historical spatial and/or temporal context to identify/verify a contraflow lane shift incident. Although various embodiments are described with respect to highways, it is contemplated that the approach described herein may be used with other roads. In addition, the above-discussed embodiments can be applied to both left-hand and right-hand traffic.

In yet another embodiment, the aggregation of the (D, D′) values across vehicles and across roadway subsegments/links can support statistical modeling of the data into the main/opposite features for probabilistic-based solutions, machine learning solutions, or other possible solutions. These solutions can identify situations where consistently and distinctly the spatial data shows that traffic has been diverted. For instances, the incident detection module 307 can apply a probabilistic function (e.g., a heuristic function), a machine learning algorithm, or a combination thereof on the main feature, the opposite feature, or a combination thereof to determine that a shift in the first lateral distance to being closer to the opposing side resulted in the lane shift (e.g., FIG. 2C). Such a heuristic function can use a simple probabilistic function based on the probe/sensor data to identify the likelihood that a shift in D-value data to being closer to the opposing road resulted in a lane closure shift.

In one embodiment, the machine learning system 125 verifies a road closure on a road segment/link based on the calculated lateral distance values and/or the lateral distance features. In one instance, the machine learning system 125 can train or condition a machine learning model (e.g., a support vector machine (SVM), neural network, decision tree, etc.) using a set of vehicle path related features or inputs (e.g., stored in and/or accessible via the probe data layer 121 and/or the geographic database 123) that indicate a vehicle volume on various paths within the road graph. By way of example, the generated features may include, but are not limited to, the number of real-time actual observed vehicle paths crossing a centerline of a road segment as well as the expected or historic volume of vehicle paths crossing a centerline of the road segment. In one embodiment, once the machine learning system 125 determines that the calculated probability for a path crossing a road centerline meets one or more probability criteria, the machine learning system 125 calculates one or more weighted or not-weighted lateral distance features for that road link for training and use with the machine learning model. In one instance, the machine learning system 125 can train the machine learning model to verify a contraflow lane shift incident on the road link by assigning weights, correlations, relationships, etc. among the features corresponding to actual and expected vehicle volumes on a road segment. In one embodiment, the machine learning system 125 can continuously provide and/or update the machine learning model during training using, for instance, supervised deep convolution networks or equivalents. In other words, the machine learning system 125 trains the machine learning model using various centerline-crossing vehicle path related features to enable the machine learning system 125 to automatically verify a contraflow lane shift incident on the road link using multiple potential centerline-crossing vehicle paths.

In one instance, the machine learning system 125 can calculate a centerline-crossing path probability and assign a weighted or not-weighted vehicle count over one or more other sets of probe/sensor data. A contraflow lane shift incident can be detected based on the calculation over the other sets of probe/sensor data. For example, this approach may be repeated over all vehicles 103 monitored during one or more time periods in the road network. The resulting weighted paths can then be summed over all vehicles' paths and the aggregate result may be assigned as a volume feature value to each road segment. In this way, the information coming from the paths with high probabilities are included by the machine learning model. Such machine learning model can not only identify/verify a contraflow lane shift incident, but also identifying what breakpoints of the features to begin the incident.

It is contemplated that by processing different lane closure scenarios and manipulations of the various thresholds and probability criterion, the system 100 and/or the machine learning system 125 can derive better metrics for automatically identifying/verifying road closures and/or scoring such identification/verifications against some sort of ground truth (e.g., a human verified closure).

In one embodiment, the incident detection module 307 can receive a notification of a lane closure incident, and verify the lane closure incident with the lane shift.

In one embodiment, the output module 309 can provide a representation of the main feature and the opposite feature as lines spatially across the bi-directional road (e.g., FIG. 2C). In one embodiment, the incident detection module 307 can identify the lane shift where the lines cross over each other.

In one embodiment, the data processing module 301 can process a plurality of vehicle data points across the main strand graph of the main side of the bi-directional road to normalize, interpolate, or a combination thereof, the lane shift.

In one embodiment, in step 407, the output module 309 can provide the lane shift as an output. In addition to the lane shift, the output module 309 can add/supplement incident information from algorithm conclusions, external sources (e.g., cloud-sourced images), etc. By way of example, the output module 309 can add construction labels to both sides of the road, in addition to inform a type of lane closure.

In one embodiment, the traffic platform 107 can receive a reported lane closure incident for verification. the traffic platform 107 can ping a map service to create a main road strand graph and algorithmically discovers an opposite strand graph. Such functionality can be partially available in mapping services, and can be expanded upon. The traffic platform 107 can retrieve D-values and calculate D′-values for probe/sensor data points matched to the main strand graph and the opposite strand graph. The traffic platform 107 can aggregate probe/sensor data points by links to generate feature data based on the (D, D′) values, via median, mean, percentiles, etc. The traffic platform 107 can then create a dynamic window of the feature data based on an expected vehicle volume. By way of example, the expected vehicle volume data may comprise individual statistics such as unique historical vehicles 103 for each road segment in each of the time epochs, summary statistics (e.g., mean, median, etc.), or a combination thereof. In one instance, the expected vehicle volumes may include contextual and/or temporal data such as the day of the week, the time of day, the weather, the road conditions, etc.

Either a heuristic solution or a machine learning solution can be applied to decide if the feature data shows a lane shift into the opposite strand graph. The heuristic solution can be a simple probabilistic function based on the data to identify the likelihood that a shift in D-value data to being closer to the opposing road resulted in a lane closure shift. In one embodiment, The traffic platform 107 can post-process data across the strand graph to normalize/interpolate a complete lane closure.

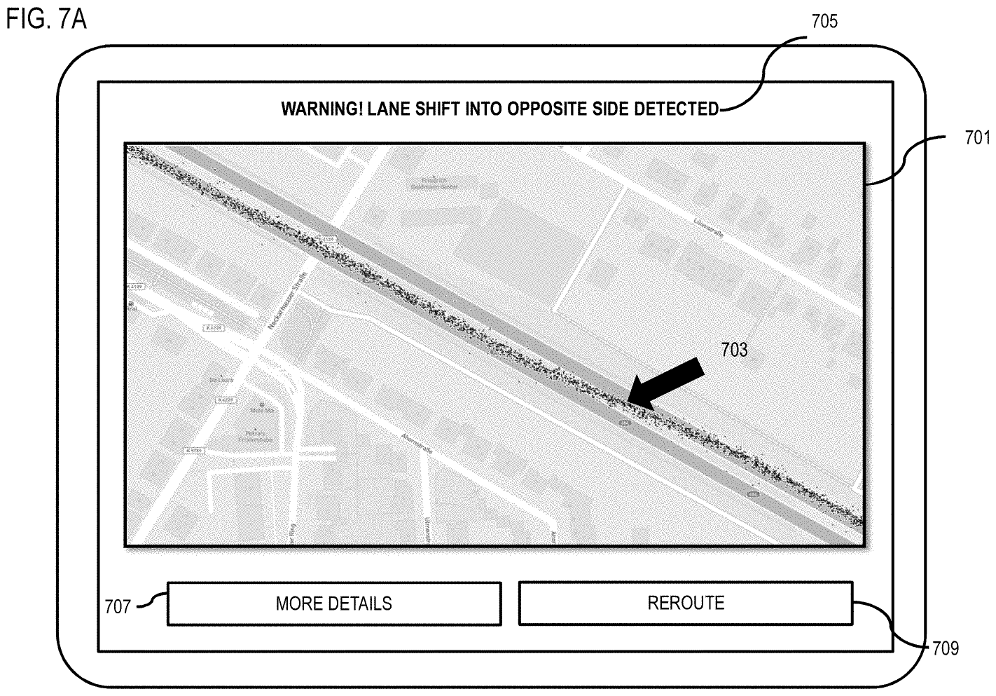

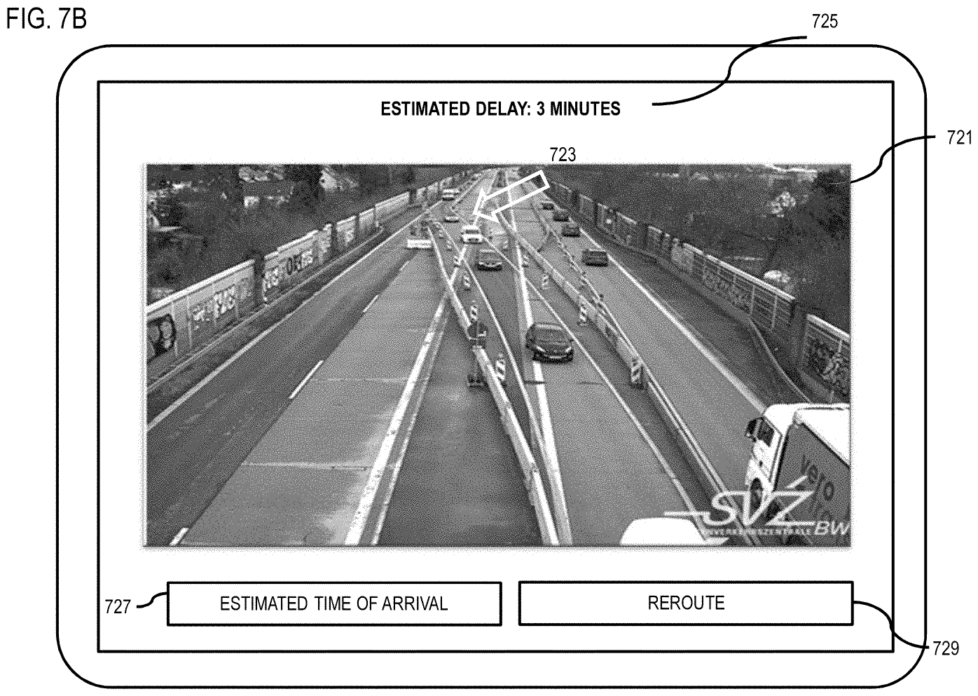

FIGS. 7A and 7B are diagrams of example user interfaces of a detected contraflow lane shift incident, according to various embodiment. The user interface in FIG. 7A (e.g., a navigation application 113) is generated for a UE 111 (e.g., a mobile device, an embedded navigation system, a client terminal, etc.). The user interface in FIG. 7A shows a map 701, an arrow 703 pointing towards a detected contraflow lane shift incident on a user's route in the map 701, and an alert 705: “Warning! Lane Shift into Opposite Side detected.” The user interface in FIG. 7A also shows a “More Details” button 707 and a “Reroute” button 709. For examples, a user can interact with the user interfaces via one or more physical interactions (e.g., a touch, a tap, a gesture, typing, etc.), one or more voice commands (e.g., “verify road closure,” “flag road closure,” etc.), or a combination thereof.

When the user selects the “More Details” button 707, the user interface in FIG. 7B shows a live traffic image 721, an arrow 723 pointing towards the detected contraflow lane shift incident in the image 721, and an alert 725: “Estimated Delay: 3 minutes.” The user interface in FIG. 7B also shows an “Estimated Time of Arrival” button 727 and a “Reroute” button 729.

When the user selects the “Reroute” button 709, the user may confirm that the routing or guidance determined by the system 100 including road closures is accepted. This is particularly true in the case of a user that is a passenger in an autonomous vehicle. It is contemplated that in this instance, the system 100 can determine or detect one or more actions by a user (e.g., an eye gaze) and automatically confirm the acceptance.

The above-discussed embodiments provide simple (e.g., not requiring long-term historical context) and effective (e.g., computational inexpensive, less susceptible to location sensor data statistical variability and/or errors caused by road structures) ways to create lateral distance data features to identify road sharing incidents. In addition, machine learning and/or heuristic/probabilistic algorithms can be added to identify road sharing incidents. Information of the road sharing incidents can be used to improve incident mapping and reporting, navigation (e.g., autonomous driving), traffic, road design, etc.

Returning to FIG. 1, in one embodiment, the traffic platform 107 performs the process for detecting/verifying contraflow lane shift incidents using bidirectional lateral distance measurements as discussed with respect to the various embodiments described herein. For example, the traffic platform 107 can generate vehicle path related features for machine learning solutions.

In one embodiment, the machine learning system 125 of the traffic platform 107 includes a neural network or other machine learning system to compare (e.g., iteratively) vehicle paths features and/or enhanced vehicle path features (e.g., using soft vehicle paths) to expected values for these features on reported road segments. For example, when the inputs are features/flags indicating a reduction of vehicle volume and/or vehicle path data in a monitored area, the output can include an evaluation as to whether a road segment in the monitored area is closed or not. In one embodiment, the neural network of the machine learning system 125 is a traditional convolutional neural network which consists of multiple layers of collections of one or more neurons (which are configured to process a portion of an input data). In one embodiment, the machine learning system 125 also has connectivity or access over the communication network 109 to the probe data layer 121 and/or the geographic database 123 that can each store probe data, labeled or marked features (e.g., historically expected volumes and/or real-time actual observed volumes on road segments), etc.

In one embodiment, the traffic platform 107 has connectivity over the communications network 109 to the services platform 115 (e.g., an OEM platform) that provides the services 117a-117n (also collectively referred to herein as services 117) (e.g., probe and/or sensor data collection services). By way of example, the services 117 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 115 uses the output (e.g. whether a road segment is closed or not) of the traffic platform 107 to provide services such as navigation, mapping, other location-based services, etc.

In one embodiment, the traffic platform 107 may be a platform with multiple interconnected components. The traffic platform 107 may include multiple servers, intelligent networking devices, computing devices, components and corresponding software for providing parametric representations of lane lines. In addition, it is noted that the traffic platform 107 may be a separate entity of the system 100, a part of the services platform 115, a part of the one or more services 117, or included within a vehicle 103 (e.g., an embedded navigation system).

In one embodiment, content providers 119 may provide content or data (e.g., including road closure reports, probe data, expected vehicle volume data, etc.) to the traffic platform 107, the UEs 111, the applications 113, the services platform 115, the services 117, the probe data layer 121, the geographic database 123, and the vehicles 103. The content provided may be any type of content, such as map content, textual content, audio content, video content, image content, etc. In one embodiment, the content providers 119 may provide content regarding the expected frequency of vehicles 103 on the digital map or link as well as content that may aid in localizing a vehicle path or trajectory on a digital map or link (e.g., to assist with determining actual vehicle volumes on a road network). In one embodiment, the content providers 119 may also store content associated with the traffic platform 107, the services platform 115, the services 117, the probe data layer 121, the geographic database 123, and/or the vehicles 103. In another embodiment, the content providers 119 may manage access to a central repository of data, and offer a consistent, standard interface to data, such as a repository of the probe data layer 121 and/or the geographic database 123.

By way of example, the UEs 111 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 111 can support any type of interface to the user (such as “wearable” circuitry, etc.). In one embodiment, a UE 111 may be associated with a vehicle 103 (e.g., a mobile device) or be a component part of the vehicle 103 (e.g., an embedded navigation system). In one embodiment, the UEs 111 may include the traffic platform 107 to detect/verify contraflow lane shift incidents using bidirectional lateral distance measurements.

In one embodiment, as mentioned above, the vehicles 103, for instance, are part of a probe-based system for collecting probe data for detecting actual and expected vehicle volumes on a road network and/or measuring traffic conditions in a road network (e.g., free flow traffic versus a road closure). In one embodiment, each vehicle 103 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 103 may include vehicle sensors 105 for reporting measuring and/or reporting attributes. The attributes can also be any attribute normally collected by an on-board diagnostic (OBD) system of the vehicle 103, and available through an interface to the OBD system (e.g., OBD II interface or other similar interface).

The probe points can be reported from the vehicles 103 in real-time, in batches, continuously, or at any other frequency requested by the system 100 over, for instance, the communication network 109 for processing by the traffic platform 107. The probe points also can be map matched to specific road links stored in the geographic database 123. In one embodiment, the system 100 (e.g., via the traffic platform 107) generates vehicle paths or trajectories from the observed and expected frequency of probe points for an individual probe as discussed with respect to the various embodiments described herein so that the probe traces represent a travel trajectory or vehicle path of the probe through the road network.

In one embodiment, as previously stated, the vehicles 103 are configured with various sensors (e.g., vehicle sensors 105) for generating or collecting probe data, sensor data, related geographic/map data, etc. In one embodiment, the sensed data represents sensor data associated with a geographic location or coordinates at which the sensor data was collected (e.g., a latitude and longitude pair). In one embodiment, the probe data (e.g., stored in the probe data layer 121) includes location probes collected by one or more vehicle sensors 105. By way of example, the vehicle sensors 105 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travels through road segments of a road network.

Other examples of sensors 105 of a vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of a vehicle 103 along a path of travel, moisture sensors, pressure sensors, etc. In a further example embodiment, vehicle sensors 105 about the perimeter of a vehicle 103 may detect the relative distance of the vehicle 103 from a physical divider, a lane line of a link or roadway, the presence of other vehicles, pedestrians, traffic lights, potholes and any other objects, or a combination thereof. In one scenario, the vehicle sensors 105 may detect weather data, traffic information, or a combination thereof. In one embodiment, a vehicle 103 may include GPS or other satellite-based receivers 105 to obtain geographic coordinates from satellites 127 for determining current location and time. Further, the location can be determined by visual odometry, triangulation systems such as A-GPS, Cell of Origin, or other location extrapolation technologies.

In one embodiment, the UEs 111 may also be configured with various sensors (not shown for illustrative convenience) for acquiring and/or generating probe data and/or sensor data associated with a vehicle 103, a driver, a passenger, other vehicles, conditions regarding the driving environment or roadway, etc. For example, such sensors may be used as GPS receivers for interacting with the one or more satellites 127 to determine and track the current speed, position and location of a vehicle 103 travelling along a link or road segment. In addition, the sensors may gather tilt data (e.g., a degree of incline or decline of the vehicle during travel), motion data, light data, sound data, image data, weather data, temporal data and other data associated with the vehicles 103 and/or UEs 111. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via the communication network 109 as probe data (e.g., GPS probe data) according to any known wireless communication protocols. For example, each UE 111, application 113, user, and/or vehicle 103 may be assigned a unique probe identifier (probe ID) for use in reporting or transmitting said probe data collected by the vehicles 103 and/or UEs 111. In one embodiment, each vehicle 103 and/or UE 111 is configured to report probe data as probe points, which are individual data records collected at a point in time that records telemetry data.

In one embodiment, the traffic platform 107 retrieves aggregated probe points gathered and/or generated by the vehicle sensors 105 and/or the UEs 111 resulting from the travel of the UEs 111 and/or vehicles 103 on a road segment of a road network. In one instance, the probe data layer 121 stores a plurality of probe points and/or trajectories generated by different vehicle sensors 105, UEs 111, applications 113, vehicles 103, etc. over a period while traveling in a large monitored area (e.g., a stretch of roadway where a closure incident is reported). A time sequence of probe points specifies a trajectory—i.e., a path traversed by a UE 111, application 113, vehicle 103, etc. over the period. In one instance, as the time between data points increases, so does the distance and the possible routes/paths between those two points.

In one embodiment, the communication network 109 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, vehicle sensors 105, traffic platform 107, UEs 111, applications 113, services platform 115, services 117, content providers 119, and/or satellites 127 communicate with each other and other components of the system 100 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

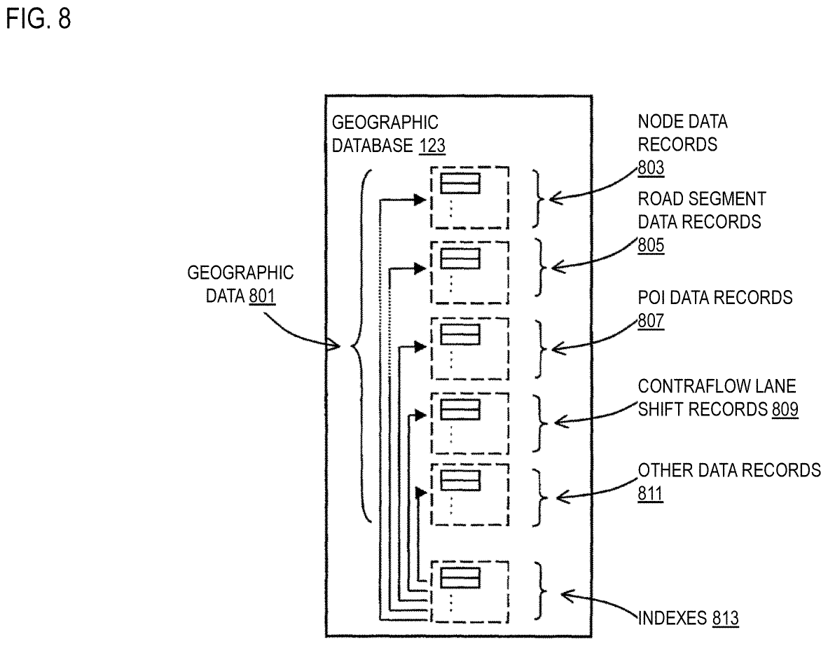

FIG. 8 is a diagram of a geographic database, according to one embodiment. In one embodiment, the geographic database 123 includes geographic data 801 used for (or configured to be compiled to be used for) mapping and/or navigation-related services. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 123.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 123 follows certain conventions. For example, links do not cross themselves and do not cross each other except at a node. Also, there are no duplicated shape points, nodes, or links. Two links that connect each other have a common node. In the geographic database 123, overlapping geographic features are represented by overlapping polygons. When polygons overlap, the boundary of one polygon crosses the boundary of the other polygon. In the geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 803, road segment or link data records 805, Point of Interest (POI) data records 807, contraflow lane shift records 809, other records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 123. In one embodiment, the indexes 813 may be used to quickly locate data without having to search every row in the geographic database 123 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points corresponding to the respective links or segments of the road segment data records 805. The road link data records 805 and the node data records 803 represent a road network, such as used by vehicles, cars, and/or other entities. Alternatively, the geographic database 123 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 807. The geographic database 123 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 123 includes contraflow lane shift records 809 for current and historical vehicle probe data, time window data, road closure detections, road closure reports, road closure evaluations, road closure link graphs, associated vehicle paths, vehicle path related features, enhanced vehicle path features, vehicle path probabilities/weights, sensor data, and/or any other related data. The contraflow lane shift records 809 include lateral distance data, lateral distance features, and/or contraflow lane shift incident data. In one embodiment, the contraflow lane shift records 809 (e.g., probabilities/weights) can be associated with segments of a road link (as opposed to an entire link). It is noted that the segmentation of the road for the purposes of verifying road closure can be different than the road link structure of the geographic database 123. In other words, the segments can further subdivide the links of the geographic database 123 into smaller segments (e.g., uniform lengths such as 1-meter, 5-meters, etc.) as well as aggregate the links and their probes into roads where it makes sense. In this way, road closures or other traffic incidents can be identified and represented at a level of granularity that is independent of the granularity or at which the actual road or road network is represented in the geographic database 123. In one embodiment, the contraflow lane shift records 809 can be associated with one or more of the node data records 803, road segment or link records 805, and/or POI data records 807; or portions thereof (e.g., smaller or different segments than indicated in the road segment records 805) to provide situational awareness to drivers and provide for safer autonomous operation of vehicles.

As mentioned, the geographic database 123 includes the probe data layer 121 that stores the vehicle paths and volume feature values generated according to the various embodiments described herein. The probe data layer 121 can be provided to other system components or end users to provide related mapping, navigation, and/or other location-based services.

In one embodiment, the geographic database 123 can be maintained by the services platform 115 (e.g., a map developer). The map developer can collect geographic data to generate and enhance the geographic database 123. There can be different ways used by the map developer to collect data. These ways can include obtaining data from other sources, such as municipalities or respective geographic authorities. In addition, the map developer can employ field personnel to travel by vehicle along roads throughout the geographic region to observe features (e.g., road closures or other traffic incidents, etc.) and/or record information about them, for example. Also, remote sensing, such as aerial or satellite photography, can be used.

In one embodiment, the geographic database 123 include high resolution or high definition (HD) mapping data that provide centimeter-level or better accuracy of map features. For example, the geographic database 123 can be based on Light Detection and Ranging (LiDAR) or equivalent technology to collect billions of 3D points and model road surfaces and other map features down to the number lanes and their widths. In one embodiment, the HD mapping data capture and store details such as the slope and curvature of the road, lane markings, roadside objects such as signposts, including what the signage denotes. By way of example, the HD mapping data enable highly automated vehicles to precisely localize themselves on the road, and to determine road attributes (e.g., learned speed limit values) to at high accuracy levels.

In one embodiment, the geographic database 123 is stored as a hierarchical or multi-level tile-based projection or structure. More specifically, in one embodiment, the geographic database 123 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 123 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103, a vehicle sensor 105 and/or a UE 111. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting/verifying contraflow lane shift incidents using bidirectional lateral distance measurements may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

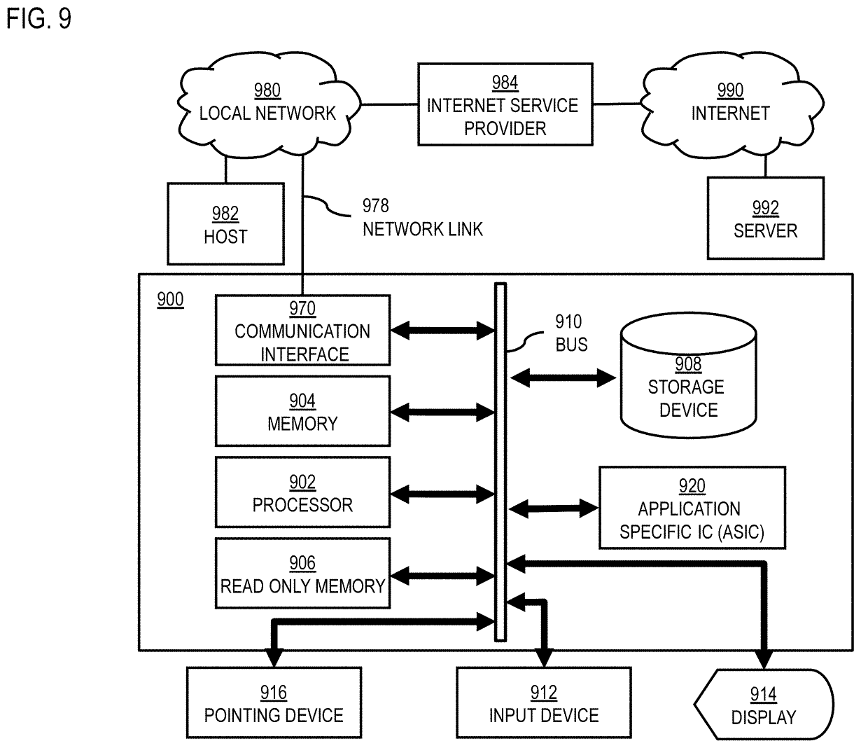

FIG. 9 illustrates a computer system 900 upon which an embodiment of the invention may be implemented. Computer system 900 is programmed (e.g., via computer program code or instructions) to detect/verify contraflow lane shift incidents using bidirectional lateral distance measurements as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to automatically verifying a road closure using multiple possible vehicle paths. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RANI) or other dynamic storage device, stores information including processor instructions for detecting/verifying contraflow lane shift incidents using bidirectional lateral distance measurements. Dynamic memory allows information stored therein to be changed by the computer system 900. RANI allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for detecting/verifying contraflow lane shift incidents using bidirectional lateral distance measurements, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 109 for detecting/verifying contraflow lane shift incidents using bidirectional lateral distance measurements.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to detect/verify contraflow lane shift incidents using bidirectional lateral distance measurements as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to detect/verify contraflow lane shift incidents using bidirectional lateral distance measurements. The memory 1005 also stores the data associated with or generated by the execution of the inventive steps.

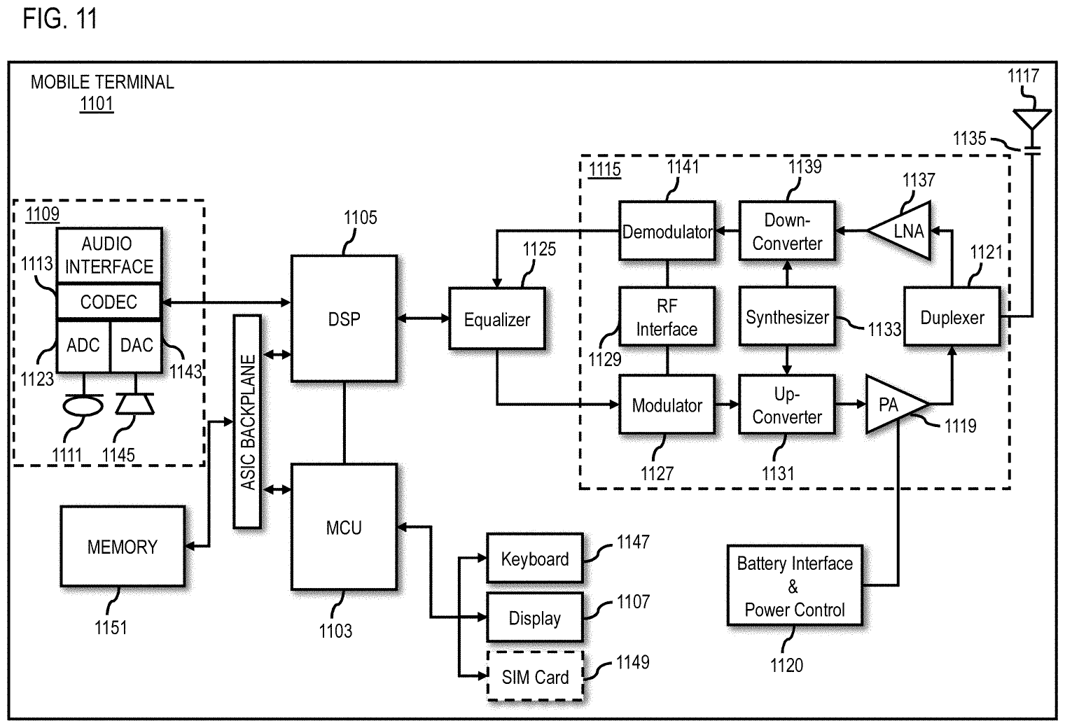

FIG. 11 is a diagram of exemplary components of a mobile terminal 1001 (e.g., a vehicle 103, a UE 111, or a component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a lane-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to detect/verify contraflow lane shift incidents using bidirectional lateral distance measurements. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
for each one of a plurality of vehicle data points travelling at a main direction of a main side of a bi-directional road, determining a first lateral distance to a center of the main side and a second lateral distance to a center of an opposite side of the bi-directional road;
for the plurality of vehicle data points, aggregating the first lateral distance into a main feature and aggregating the second lateral distance into an opposite feature;
identifying a lane shift to the opposite side based on the main feature, the opposite feature, or a combination thereof; and
providing the lane shift as an output.

2. The method of claim 1, further comprising:
for each said vehicle data point, calculating a median, a mean, a percentile, or a combination thereof of the first lateral distance and the second lateral distance respectively,
wherein the median, the mean, the percentile, or a combination thereof are aggregated to generate the main feature and the opposite feature respectively.

3. The method of claim 2, further comprising:
providing a representation of the main feature and the opposite feature as lines spatially across the bi-directional road.

4. The method of claim 3, wherein the lane shift is identified where the lines cross over each other.

5. The method of claim 3, wherein the lane shift is identified where the line corresponding to the first feature is diverted to the opposite side.

6. The method of claim 1, further comprising:
applying a probabilistic function, a machine learning algorithm, or a combination thereof on the main feature, the opposite feature, or a combination thereof to determine that a shift in the first lateral distance to being closer to the opposing side resulted in the lane shift.

7. The method of claim 1, further comprising:
receiving a notification of a lane closure incident;
verifying the lane closure incident with the lane shift.

8. The method of claim 1, further comprising:
retrieving a main strand graph of the main side of the bi-directional road;
algorithmically determining an opposite strand graph of the opposite side of the bi-directional road based on the main strand graph; and
determining the center of the main side and the center of the opposite side of the bi-directional road based on the main strand graph and the opposite strand graph respectively.

9. The method of claim 1, wherein the first lateral distance is calculated during a map-matching process of a main strand graph of the main side of the bi-directional road.

10. The method of claim 1, further comprising:
processing the plurality of vehicle data points across a main strand graph of the main side of the bi-directional road to normalize, interpolate, or a combination thereof, the lane shift.

11. The method of claim 1, wherein the plurality of vehicle data points include one or more probe data points, one or more sensor data points, or a combination thereof.

12. An apparatus comprising:
at least one processor; and
at least one memory including computer program code for one or more programs,
the at least one memory and the computer program code configured to, with the at least one processor, cause the apparatus to perform at least the following,
for each one of a plurality of vehicle data points travelling at a main direction of a main side of a bi-directional road, determine a first lateral distance to a center of the main side and a second lateral distance to a center of an opposite side of the bi-directional road;
for the plurality of vehicle data points, aggregate the first lateral distance into a main feature and aggregate the second lateral distance into an opposite feature;
identify a lane shift to the opposite side based on the main feature, the opposite feature, or a combination thereof; and
provide the lane shift as an output.

13. The apparatus of claim 12, wherein the apparatus is further caused to:
for each said vehicle data point, calculate a median, a mean, a percentile, or a combination thereof of the first lateral distance and the second lateral distance respectively,
wherein the median, the mean, the percentile, or a combination thereof are aggregated to generate the main feature and the opposite feature respectively.

14. The apparatus of claim 13, wherein the apparatus is further caused to:
provide a representation of the main feature and the opposite feature as lines spatially across the bi-directional road.

15. The apparatus of claim 14, wherein the lane shift is identified where the lines cross over each other.

16. The apparatus of claim 14, wherein the lane shift is identified where the line corresponding to the first feature is diverted to the opposite side.

17. The apparatus of claim 12, wherein the apparatus is further caused to:
apply a probabilistic function, a machine learning algorithm, or a combination thereof on the main feature, the opposite feature, or a combination thereof to determine that a shift in the first lateral distance to being closer to the opposing side resulted in the lane shift.

18. A non-transitory computer-readable storage medium carrying one or more sequences of one or more instructions which, when executed by one or more processors, cause an apparatus to perform:
for each one of a plurality of vehicle data points travelling at a main direction of a main side of a bi-directional road, determining a first lateral distance to a center of the main side and a second lateral distance to a center of an opposite side of the bi-directional road;
for the plurality of vehicle data points, aggregating the first lateral distance into a main feature and aggregating the second lateral distance into an opposite feature;
identifying a lane shift to the opposite side based on the main feature, the opposite feature, or a combination thereof; and
providing the lane shift as an output.

19. The non-transitory computer-readable storage medium of claim 18, wherein the apparatus is caused to further perform:
for each said vehicle data point, calculating a median, a mean, a percentile, or a combination thereof of the first lateral distance and the second lateral distance respectively,
wherein the median, the mean, the percentile, or a combination thereof are aggregated to generate the main feature and the opposite feature respectively.

20. The non-transitory computer-readable storage medium of claim 19, wherein the apparatus is caused to further perform:
providing a representation of the main feature and the opposite feature as lines spatially across the bi-directional road.
